(19) United States
(12) Patent Application Publication
(10) Pub. No.: US 2003/0144860 A1
(43) Pub. Date: Jul. 31, 2003

(54) Dynamic conversation logic selection method and system

(76) Inventors: Fabio Casati, Palo Alto, CA (US); Ming-Chien Shan, Saratoga, CA (US)

Correspondence Address: HEWLETT-PACKARD COMPANY, Intellectual Property Administration, P.O. Box 272400, Fort Collins, CO, 80527-2400, US

(21) Appl. No.: 10/066,098

(22) Filed: Jan. 31, 2002

(51) Int. Cl. G06F 17/60

(52) U.S. Cl. 705/1

(57) ABSTRACT

Method and system for dynamically selecting a conversation logic at run-time. First, a workflow/composite service engine maintains a repository that has at least one conversation logic. Each conversation logic may be associated to one or more services. At run-time, when the engine needs to execute a node in a work flow that has an unspecified service and an unspecified conversation logic, the engine sends a service selection query to an application (e.g., an e-services platform). Based on the service returned, the dynamic conversation logic selection mechanism selects an appropriate conversation logic from the repository. Entries in the conversation logic repository may be for the exclusive use of a given composite service or shared by two or more composite services.

### FIELD OF THE INVENTION

The present invention relates generally to electronic business technology, and more particularly, to dynamic conversation logic selection method and system.

### BACKGROUND OF THE INVENTION

The Web is rapidly becoming the platform through which many companies deliver services to businesses and individual customers. The number and type of on-line services increases day by day, and this trend is likely to continue at an even faster pace in the immediate future. Examples of e-services currently available include bill payment, delivery of customized news, or archiving and sharing of digital documents.

E-Services are typically delivered individually. However, the e-service market creates the opportunity for providing value-added, integrated services, which are delivered by composing existing e-services. To support organizations in pursuing this business opportunity, e-service platforms are being developed that support the specification, enactment, and management of composite e-services, modeled as processes that are enacted by a service process engine (also called workflow engine).

Examples of these e-service platforms include BizTalk available from Microsoft, Inc. of Redmond, Wash., Jini, available by Sun Microsystems, Inc. of Cupertino, Calif., and HP Process Manager, available from Hewlett Packard of Palo Alto, Calif.

In most e-service description models, an E-service is a complex entity (e.g., a Java object) that offers several methods or operations that can be invoked. For instance, a car rental service may offer operations to browse the set of available cars and the respective rental prices, to book a car, or to cancel a reservation. In order to achieve a particular business goal, clients typically invoke several operations on the same service. For example, with regard to a car rental service, the client may browse available cars, negotiate a price for the rental, and then possibly make a reservation. The complete set of interactions with a service is typically called a conversation.

One of most advocated and publicized features of e-services platforms is dynamic service discovery. Dynamic service discovery is a feature that allows workflow/service composition languages to select at run-time the best available service. For example, when a service invocation step is started, the best available service may be selected based on a service selection rule. The dynamic service discovery feature advantageously provides flexibility and enables the choice of the best available service based on the needs of a specific workflow instance in which the service is invoked (e.g., based on the value of particular workflow variables). Unfortunately, the dynamic service discovery feature introduces the problem of how to manage the conversation with the dynamically selected service.

FIG. 1 illustrates a prior art system 1 where hard-coded conversation logic is utilized. The system 1 includes a workflow definition 2 that includes hard-coded conversation logic 3 that is specific for a particular conversation protocol 4. Those services (e.g., service_1) with the particular conversation protocol 4 can interact with the workflow definition 2. Unfortunately, those services that have a conversation protocol that is different from the particular conversation protocol 4 could be unable to interact with the workflow definitions 2. For example, when a service (e.g., service_2) whose conversation protocol is not compatible with the hard-coded conversation logic 3 attempts to interact with the workflow definition 2, there is failure. As can be appreciated, the hard-coded conversation logic 3 limits the interaction of a workflow engine with those services (e.g., service_1) with a conversation protocol that is compatible with the hard-coded conversation logic 3.

Different providers may offer the same type of service. While in some cases, an industry standard (e.g., RosettaNet) may define the interface for a particular type of service, in many other cases, different service providers specify different interfaces for the same type of service. As can be appreciated, when the conversation logic (i.e., the flow of method invocations) is statically defined at composite service definition time, there is a risk that the conversation itself is not consistent or compatible with the conversation protocol provided at run-time by the dynamically selected service.

In this regard, there is the need for a mechanism that waives the requirement for a designer to define the conversation logic at specification time. As can be appreciated, the removal of hard-coded conversation logic poses numerous challenges to prior art workflow systems.

Based on the foregoing, there remains a need for a mechanism to enable a workflow to interact with dynamically discovered services without hard-coded conversation logic and that overcomes the disadvantages set forth previously.

### SUMMARY OF THE INVENTION

According to one embodiment, a mechanism for dynamically selecting conversation logic at run-time is provided.

The dynamic conversation logic selection mechanism enables the interaction with dynamically discovered services by late-binding the conversation logic at run-time. By utilizing the dynamic conversation logic selection mechanism of the present invention, a designer is not required to define the conversation logic at workflow specification time (i.e., a designer is not required to hard-code the conversation logic at workflow specification time). Instead, the dynamic conversation logic selection mechanism of the present invention allows a designer to specify that conversation logic to be followed within a given service invocation step, is to be selected at run-time. For example, at run-time a service selection query may be executed as part of dynamic service discovery. The service selection query may return a service identifier that specifies the service to be utilized. The dynamic conversation logic selection mechanism employs the service identifier to select a conversation logic for interacting with the service.

In one embodiment, the conversation logic may be stored in single location, such as a conversation logic repository. In this manner, managing changes to these conversation logic or additions of new conversation logic is simplified. For example, when Avis car rental service changes its conversation protocol, then the workflow administrator need only change the conversation logic in the conversation logic repository rather than modifying every single workflow that uses the Avis car rental service.

According to another embodiment of the present invention, the selection of the conversation logic includes the following processing steps. First, a system that can execute a business process (e.g., a workflow/composite service engine) maintains a repository of conversation logic. Each conversation logic may be associated to one or more services. For example, when there are two car rental services (e.g., Avis car rental services and Hertz car rental services), a designer may define two conversation logics in the conversation logic repository (i.e., a first conversation logic for reserving cars from Avis, and a second conversation logic for reserving cars from Hertz). At run-time, when the engine needs to invoke a service, the engine sends a service selection query to an application that is capable of selecting an actual service provider based on some selection criteria. This application can be, for example, an e-services platform. Based on the service returned, the dynamic conversation logic selection mechanism selects appropriate conversation logic from the repository. Entries in the conversation logic repository may be for the exclusive use of a given composite service or shared by two or more composite services.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a prior art system that utilizes hard-coded conversation logic that is predetermined at the time where the workflow definition is specified.

FIG. 2 illustrates a system that employs the dynamic conversation logic selection mechanism according to one embodiment of the present invention.

FIG. 3 illustrates in greater detail the dynamic conversation logic selection mechanism according to one embodiment of the present invention.

FIG. 4 is a flowchart illustrating the processing steps performed by the system of FIG. 2.

FIG. 5 illustrates two exemplary car rental services.

FIG. 6 illustrates an exemplary workflow that utilizes one of the two car rental services of FIG. 5.

FIG. 7 illustrates an exemplary restaurant reservation service.

FIG. 8 illustrates an exemplary award ceremony service definition that includes an invocation of the restaurant reservation service of FIG. 7.

FIG. 9 illustrates a flow of method invocations in the restaurant reservation service node of FIG. 8.

FIG. 10 illustrates how an exemplary service engine processes events and notification of service completions to schedule service node executions.

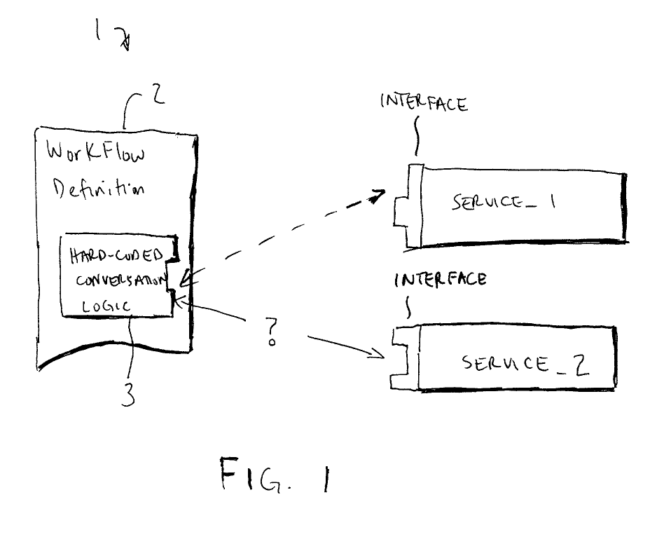

### DETAILED DESCRIPTION

A method and system for dynamic conversation logic selection are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

As used herein, the terms workflow, process, and composite service are synonymous and refer to a procedure that executes a complex service by invoking and composing other services. However, it is noted that the method and system for dynamic conversation logic selection may be applied to any computer program written in a programming language.

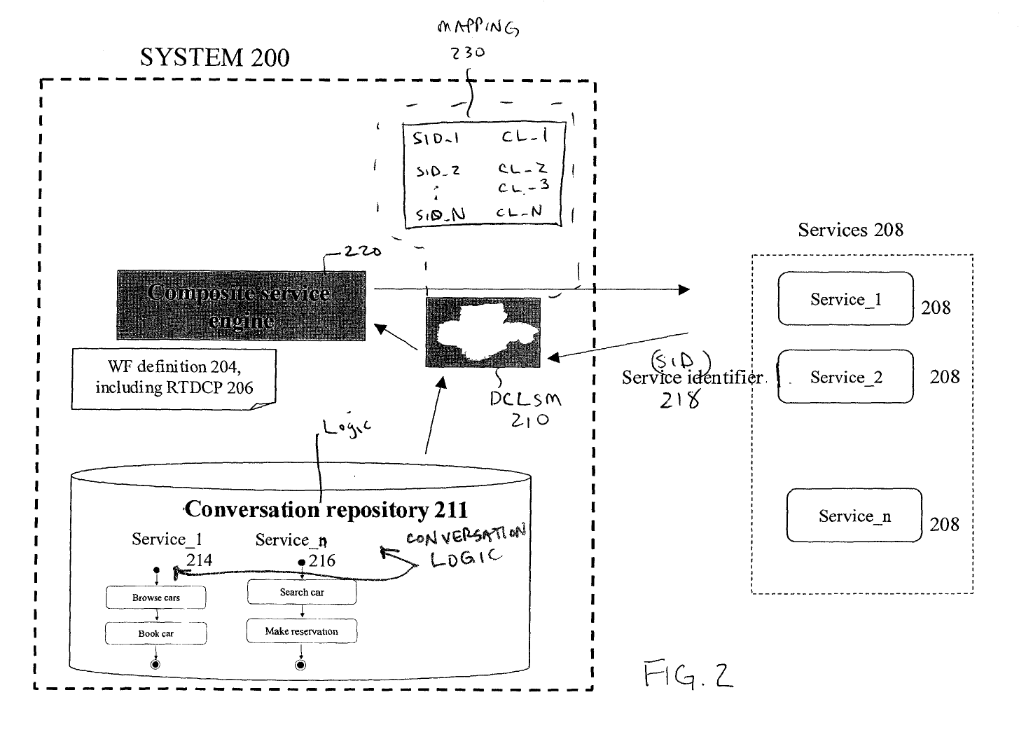

FIG. 2 illustrates a system 200 that employs the dynamic conversation logic selection mechanism (DCLSM) 210 according to one embodiment of the present invention. The system 200 includes a workflow definition 204 that may need to invoke one or more different services 208 (e.g., service_1 service_2, . . . , service_N) during its execution. Each service supports a conversation protocol. As used herein, the term “conversation protocol” refers to a set of rules to be followed when interacting with a particular service. Different services can have the same conversation protocol or have different conversation protocols. The term “conversation logic” as used herein refers to the specification of the operations to be invoked on a service, as well as, when and under which conditions the operation are to be invoked. The term “conversation” as used herein refers to a set of interactions (e.g., a sequence of operation invocations) between the workflow and the service. Conversations take place according to the specified conversation logic and within the rules defined by the conversation protocol.

The system 200 includes the dynamic conversation logic selection mechanism (DCLSM) 210 of the present invention. The dynamic conversation selection logic mechanism (DCLSM) 210 includes a conversation logic repository (CLR) 211 for storing one or more conversation logic. When there is one conversation logic, the process definition 204 is able to invoke services whose conversation protocol is compatible with the conversation logic that resides in the conversation logic repository (CLR) 211.

Preferably, the CLR 211 includes more than one conversation logic. For example, the CLR 211 can include at least two different protocols (e.g., a first conversation logic 214 and a second conversation logic 216). The DCLSM 210 receives a service identifier 218 for specifying a particular service for execution. Based on the service identifier (SID) 218, the DCLSM 210 automatically selects at run-time a conversation logic that is tailored for or is compatible with the conversation protocol of the service identified by the service identifier 218.

When there is no conversation logic in the CLR 211 that is associated with a particular service (i.e., no conversation logic to interact with a particular conversation protocol), an exception (e.g., an error message) is sent to the engine 220. Furthermore, when there are inconsistencies between the conversation logic and the service conversation protocol that can stem, for example, when a service modifies its conversation protocol, and the designer does not update the conversation logic in the repository, an exception is raised.

The engine 220 includes an error handling mechanism (EHM) 224 for managing errors. For example, the error handling mechanism (EHM) 224 can halt the workflow and notify a system administrator of the error. In response to the error, the system administrator can develop, for example, a conversation logic that is tailored for the conversation protocol of the particular service being selected.

In one embodiment, the conversation logic is defined by providing at run time a workflow fragment that is to be executed in place of the workflow node when this conversation logic is selected within the execution of the node. The DCLSM 210 can also include a mapping 230 that associates a list of service identifiers with corresponding conversation logic. It is noted that each service identifier can be associated with one or more different conversation logic. The mapping 230 can be generated by a developer. When a service with a particular service identifier in the mapping 230 is selected for execution for a workflow node, the conversation logic associated with the service identifier is executed.

When there are multiple conversation logic or protocols in the conversation logic repository (CLR) 211 that are associated to the same service identifier, the DCLSM 210 may select the conversation logic in a non-deterministic way (i.e., at random), based on a round-robin policy, or based on priorities associated with the conversation logic.

When a number of different services may be utilized for a step (e.g., a workflow node) in the process, a designer can require that only services that support a conversation protocol, which is compatible (i.e., does not cause run-time exceptions) with one of the conversation logic present in the CLR 211, be selected for this step.

The workflow definition 204 includes a run-time determined conversation logic (RTDCL) 206. At run-time the DCLSM 210 automatically selects a conversation logic based on the service identifier 218. The selected conversation logic becomes the RTDCL 206 that is used by the node to interact with the service. For example, when service_1 has been selected, the DCLSM 210 selects the first conversation logic 214 as the RTDCL 206 for interacting with service_1. Similarly, when service_N has been selected, the DCLSM 210 selects the Nth conversation logic 216 as the RTDCL 206 for interacting with service_N.

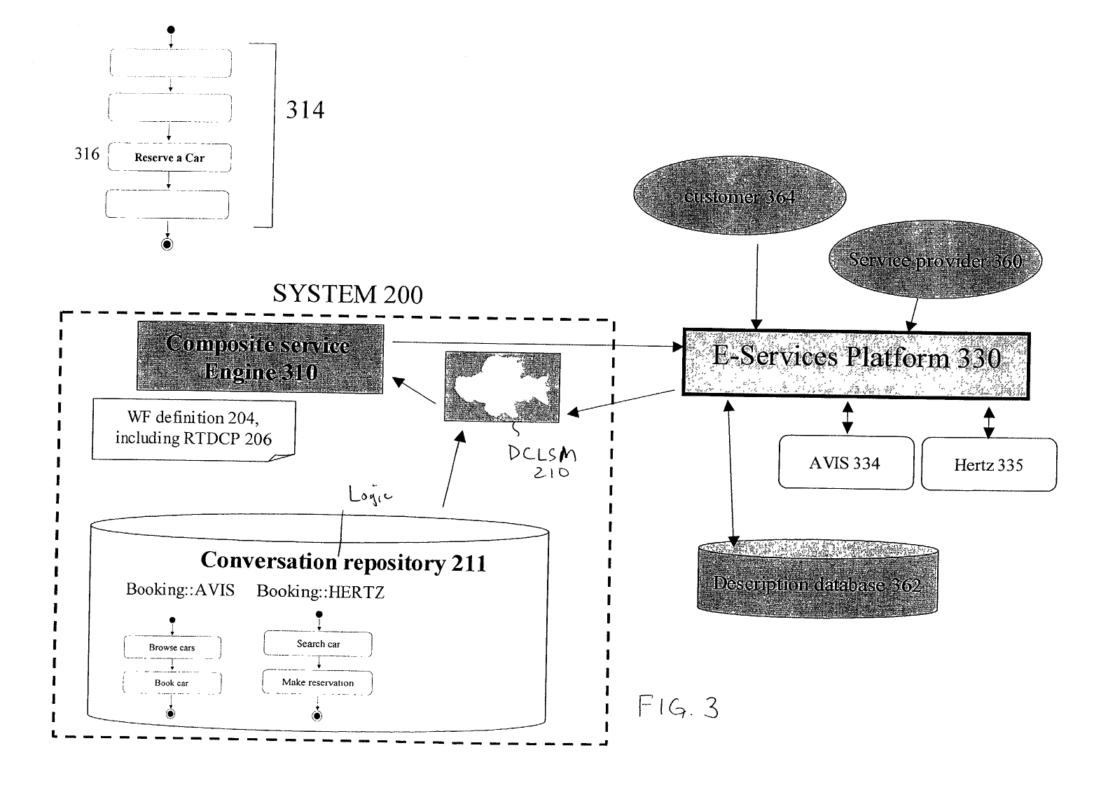

FIG. 3 illustrates in greater detail the dynamic conversation logic selection mechanism according to one embodiment of the present invention. The dynamic conversation logic selection mechanism 210 includes a service engine 310 for executing nodes in a workflow 314, a conversation logic repository (CLR) 211 for storing conversation logic, and a source 330 of at least one service.

For example, the source 330 can be, but is not limited to an e-services platform 330, a service broker, a service marketplace, another company, or other entity. In this example, the services platform 330 has access to two e-services (Avis rental car service 334 and Hertz rental car service 335). The service engine 310 (e.g., a composite service engine) executes a node 316 (e.g., “Reserve a Car”) that employs a service, which may be provided by more than one service provider. The service engine 310 requests the e-services platform 330 to select a particular service (e.g., the AVIS car rental service 334 or the HERTZ car rental service 335) to utilize. For example, the platform 330 can execute a service selection rule sent by the engine 310.

The e-services platform 330 provides a service identifier 340 of the selected service to the DCLSM 210. The DCLSM 210 accesses the conversation logic repository (CLR) 211 and dynamically plugs-in a compatible or suitable conversation logic based on the service identifier.

Preferably, the conversation logic is stored in a single location, such as a central database. Alternatively, the conversation logic can be stored in individual files that may be distributed across different locations. One advantage of having a single repository in a central location is that the maintenance of the conversation logic is simplified. For example, changes to conversation logic (e.g., newer versions of the conversations) may be made to the CLR 211 instead of every occurrence of the service in all the workflows. Similarly, new conversations need only be added to one location (e.g., the CLR 211).

An example of a service engine 310 is eFlow, which is a model and prototype engine developed by Hewlett Packard of Palo Alto, Calif., the assignee of the present patent application. eFlow is a composite service engine that runs on top of E-Services Platforms (ESPs).

E-services platforms

E-Services Platforms (ESPs) are infrastructures that enable the development, deployment, and secure delivery of e-services to businesses and customers. Although the teaching of the present invention are described in the context of a HP e-speak e-services platform (www.e-speak.hp.com), it is noted that the teachings of the present invention may be implemented with other e-services platforms, such as SUN Jini (developerjava.sun.com/developer/products/jini/), and Microsoft “.net” (www.microsoft.net).

The ESP allows service providers 360 to register descriptions of the services they offer and to advertise them in directories over the web. These descriptions may be stored in an e-service descriptions database 362. Service providers are also offered features to monitor and manage service executions.

Once a service has been registered and advertised, customers 364 can discover the service. Typically, customers 364 query the service repository associated with the ESP for services of interest, possibly also specifying ranking criteria (e.g., price) in order to get an ordered list of qualified providers. In response to the query, clients get service identifiers and references to e-services that can fulfill their needs. Then, clients can use these references to get more information about the service or the service provider, or they can immediately invoke the service.

Access to a service is restricted to authorized users, according to the security features provided by the platform. For instance, e-speak bases its security model on the Simple Public Key Infrastructure (SPKI) and on SPKI certificates, which are granted by certificate authorities and associate a set of access rights to the public key of the client. Each service provider can specify which certificate authority it trusts, and which access rights are required to use a service. The e-speak platform then controls each access to a service to verify that it is authorized.

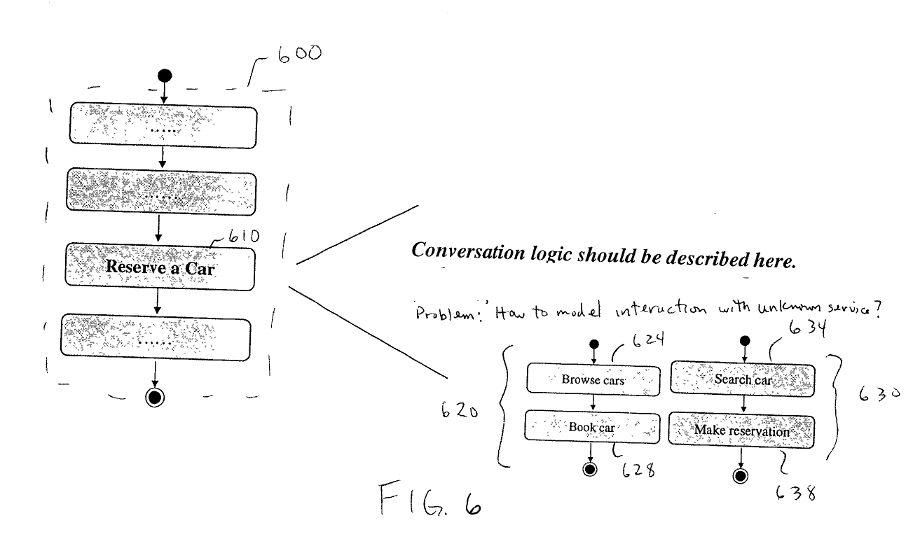

In the majority of ESP service models, a service can provide several business functions that can be invoked individually by clients. For instance, a Restaurant Reservation service may provide functionality for browsing the menus, selecting a menu, or making a reservation. FIG. 7 illustrates an exemplary restaurant reservation service.

From an implementation viewpoint, in Jini and e-speak a service is typically a Java object, which has multiple methods corresponding to the different business functions. In e-speak a service can be also modeled as an object offering a single method, in which the different business functions are specified in terms of different XML documents that can be accepted by the method.

The eFlow service composition model

In eFlow, a composite service is described as a process schema that composes other basic or composite services. A composite service is modeled by a graph (the flow structure), which defines the order of execution among the nodes in the process. At the top level, the graph defines the flow of service invocations. The graph may include service, decision, and event nodes. Service nodes represent the invocation of a basic or composite service. Decision nodes specify the alternatives and rules controlling the execution flow. Event nodes enable service processes to send and receive several types of events.

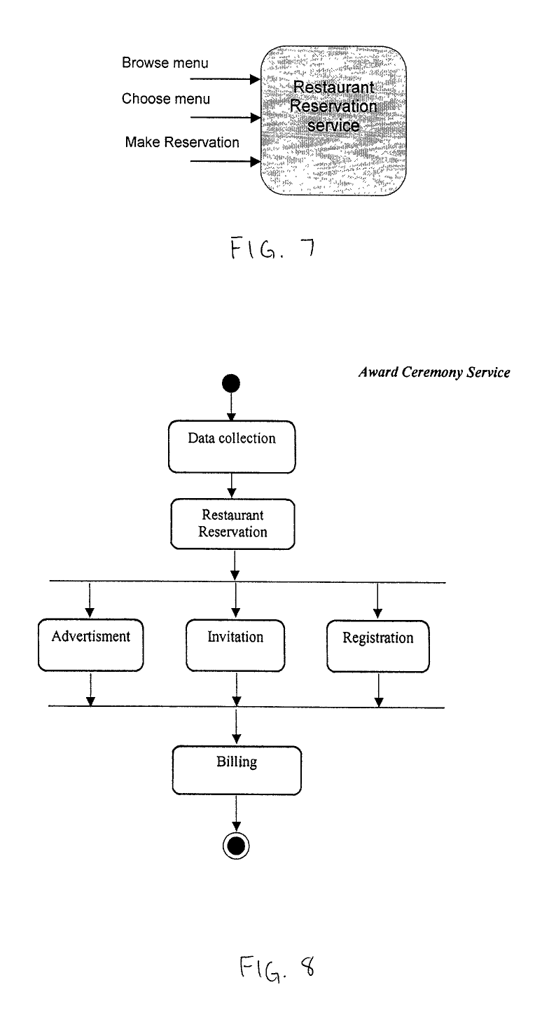

Arcs in the graph may be labeled with transition predicates defined over process data, meaning that as a node is completed, nodes connected to outgoing arcs are executed only if the corresponding transition predicate evaluates to true. A service process instance is an enactment of a process schema. The same service process may be instantiated several times, and several instances may be concurrently running. FIG. 8 shows a simple graph describing a composite service that helps customers in organizing an award ceremony, provided by the OneStopShop company.

In FIG. 8, rounded boxes represent invocations of basic or composite services, filled-in circles represent the starting and ending point of the process, while horizontal bars specify parallel invocation of services and synchronization after parallel service executions.

The semantics of the schema is as follows: when a new instance is started, service node Data Collection gathers information regarding the customer and his/her preferences and needs. Then, the Restaurant Reservation service is invoked, in order to book the restaurant and select the meals for the banquet. This node is executed first, since the characteristics of the selected restaurant (e.g., its location and the number of seats) affect the remainder of the service execution (i.e., the organization of the ceremony). Then, several services are invoked in parallel: the Advertisement service prepares a marketing campaign to advertise the ceremony, the Invitation service proposes a choice of several kinds of invitation cards and delivers them to the specified special guests, while the Registration service handles guest registrations and payments. Finally, the Billing service is invoked in order to present a unified bill to the organizing customer. All services can be either basic services (possibly provided by different organizations) or composite services, specified by eFlow processes.

As described previously, in most ESP models an e-service can have an interface that allows several operations to be invoked on them. In order to achieve their goals, clients of these services typically invoke several operations on the same service. Consequently, eFlow allows composite service designers to further refine the definition of a service node by specifying an additional, lower-level graph that defines the flow of method invocations on the selected service. Hence, the service node defines the context in which invocations are performed: it includes the specification of the service to be invoked, of the certificate to be used in invoking the service, and of exception handling rules that define how to manage errors.

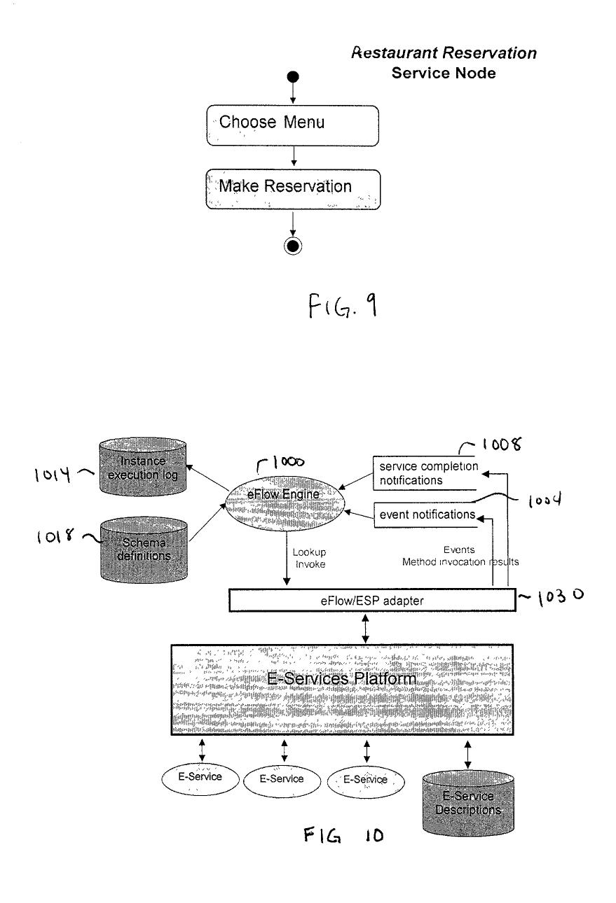

Within the service node, a flow of method invocation nodes defines the actual operations to be invoked on the service and their execution dependencies. The method flow is specified with the same syntax (and semantics) of the top-level flow of services, with the only difference that here we are concerned with the flow of method instead of service nodes. For example, in the award ceremony composite service, the invocation of the Restaurant Reservation service is composed of menu selection and the actual reservation. FIG. 9 illustrates a flow of method invocations in the restaurant reservation service node of FIG. 8.

If only one method needs to be invoked, then the designer needs not specify the flow structure, but only a single method node. The method invocation flow is referred to herein as a “conversation”.

Nodes in a composite service can access and modify data included in a case packet. Each composite service instance has a local copy of the case packet, and the eFlow engine controls access to these data. Modifications to the case packet data are applied at the end of the node execution. The specification of each method node includes the definition of the method's input and output data. TABLE I illustrates an exemplary definition of the service node Restaurant Reservation.

TABLE I
<Service-Node Name=“Restaurant Reservation”
Description=“Book a restaurant and choose a menu”>
<Service-Selection-Query>
</Service-Selection-Query>
<Method-Node Name=“Choose Menu” Description=“Select a Menu”>

<Method-Name>ChooseMenu </Method-Name>
<Method-Input>

<Value>%menu</Value>

</Method-Input>
<Method-Output>

<Var-Mapping Flow-Var=“Confirmation”/>

</Method-Output>

</Method-Node>
<Method-Node Name=“Make
Reservation”Description=“Book the restaurant”>

<Method-Name>MakeReservation </Method-Name>
<Method- Input>

<Value>%date</Value>
<Value>%seats</Value>

</Method-Input>
<Method-Output>

<Var-Mapping Flow-Var=“Confirmation” />

</Method-Output>

</Method-Node>
<Method-Flow>

<Arc Type=“Forward” Source=“Start”
Destination=“ChooseMenu” />
<Arc Type=“Forward” Source=“ChooseMenu”
Destination=“MakeReservation” />
<Arc Type=“Forward”
Source=“MakeReservation” Destination=“complete” />

</Method-Flow>
<Certificate Type=“USER” />
</Service-Node>

Service Engine

The workflow engine 1000 (e.g., eFlow engine) of FIG. 10 executes process (e.g., composite service) instances. The main function of the engine 1000 is to process messages notifying the completion of method nodes, by updating the value of case packet variables accessed by the nodes and by subsequently scheduling the next method node to be activated in the instance, according to the method flow definition. When a method flow (i.e., an interaction with a given service) is completed, then the service node is also considered completed. The engine 1000 then determines the next service node to be activated (according to the service node definition), selects the service to be executed, and eventually starts invoking the methods on the new service.

FIG. 10 illustrates how an exemplary service engine 1000 processes events and notification of service completions to schedule service node executions. The engine 1000 also processes events (either internal events detected by the eFlow event monitor or external events notified by external event managers, such as publish-subscribe systems coupled with the ESP), by delivering them to the requesting event nodes. Notifications of occurred events and of method node completions are inserted into two separate transactional First-in-First-Out queues (i.e., an event notifications queue 1004 and a service completion notification queue 1008). The engine 1000 extracts elements from the queues and processes them one by one. eFlow does not specify any priority between the queues, but it does guarantee that every element in the queues is eventually processed.

Finally, the engine 1000 logs every event related to process instance executions to enable process monitoring, compensation, and to support dynamic process modifications. For example, the logs may be stored in an instance execution log database 1014. The engine 1000 further ensures process integrity by enforcing transactional semantics and by compensating nodes executed within transactional regions in case of failures. For example, a schema definition database 1018 may be accessed for this purpose.

In this embodiment, an adapter 1130 that translates messages from the eFlow format to the one of the specific platform adopted mediates all accesses to the ESP.

As most Internet-based services, the Award Ceremony service is executed in a highly dynamic environment. For instance, providers continue to improve their e-services, and new providers may enter the market while some of the existing ones may cease their business. In addition, new types of e-services that can support the organization of an award ceremony may become available, such as renting of mega-screens and cameras, live broadcast of the ceremony over the Internet, or selection of trained personnel such as an anchorman. The conversation protocol repository allows service designers to provide composite services that naturally adapt to changes in the environment with minimal user intervention.

Processing

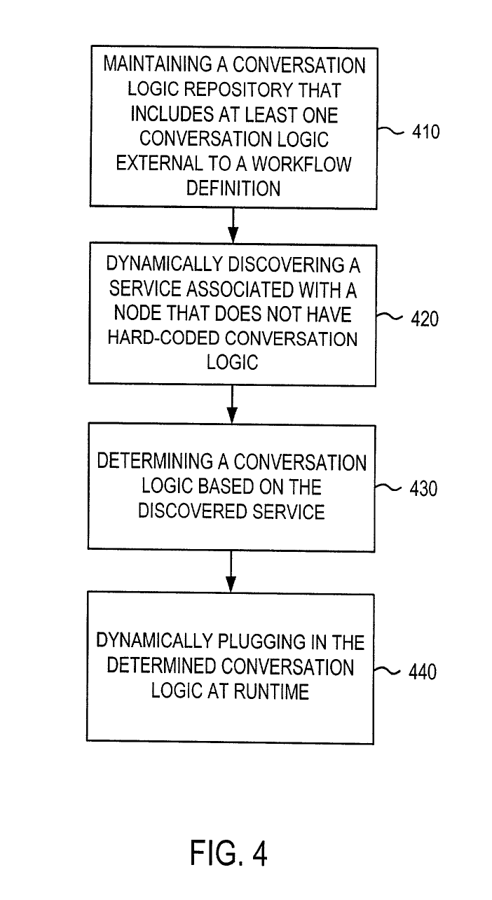

FIG. 4 is a flowchart illustrating the processing steps performed by the system of FIG. 2. In step 410, a workflow system (also referred to herein as a composite service engine or process engine) maintains a repository of conversation logic.

Each conversation logic may be associated with one or more services. For example, when there are two car rental services (Avis car rental services and Hertz car rental services), a designer may define two conversation logic in the repository (i.e., a first conversation logic for reserving cars from Avis and a second conversation logic for reserving cars from Hertz).

At run-time, when the engine needs to invoke a service, in step 420 a service that is associated with a node in a workflow definition that does not have hard-coded conversation logic is dynamically discovered. For example, the service may be discovered by the engine sending a service selection query to a source of services (e.g., an e-services platform).

Based on the service returned, in step 430 the dynamic conversation logic selection mechanism (DCLSM) determines or selects appropriate conversation logic from the repository based on the discovered service (e.g., service identifier or reference). Entries in the conversation logic repository may be for the exclusive use of a given composite service or shared by two or more composite services.

In step 440, the determined conversation logic is dynamically plugged into the node at run time.

FIG. 5 illustrates two exemplary car rental services with different conversation protocols. As described previously, different e-services can have different conversation protocols. A first car rental service 510 (e.g., AVIS car rental service) includes three methods or operations that can be invoked. A first method 514 is BROWSE_CARS. A second method 518 is BOOK_CAR, and a third method 524 is CANCEL_RESERVATION.

A second car rental service 530 (e.g., HERTZ car rental service) includes two methods or operations that can be invoked. A first method 534 is SEARCH_CAR. A second method 538 is MAKE_RESERVATION. As can be appreciated, a different conversation logic or protocol is required to interact with the first car rental service 510 as compared with the second car rental service 530.

When the conversation logic is hard-coded at the time the node is specified, the node can only interact with services that support a conversation protocolthat is compatible with the hard-coded conversation logic. In this case, if the hard-coded conversation logic is tailored for the first car rental service, then if a dynamic service discovery mechanism returns the second car rental service, the node is unable to interact with the second car rental service. Similarly, if the hard-coded conversation logic is tailored for the second car rental service, then if a dynamic service discovery mechanism returns the first car rental service, the node is unable to interact with the first car rental service.

In contrast to the prior art, the dynamic conversation selection mechanism of the present invention dynamically plugs-in the appropriate conversation logic at run-time based on the particular service that is selected.

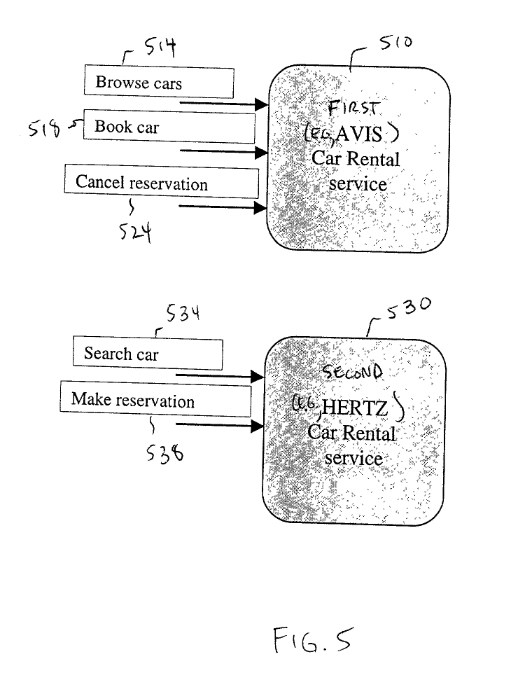

FIG. 6 illustrates an exemplary workflow 600 that utilizes one of the two car rental services of FIG. 5. The workflow 600 includes a node 610 for reserving a car. In this example, there are two car rental services, each with its own conversation protocol. The first car rental service 510 can, for example, support a first conversation logic 620 that has a first node 624 in which cars are browsed and a second node 628 where a car is booked. The second car rental service 530 can, for example, support a second conversation logic 630 that has a first node 634 in which cars are searched and a second node 638 where a reservation is made.

Since the service is unknown until run-time (i.e., unknown until the dynamic service discovery mechanism determines the service at run-time), it is difficult, if not impossible, for prior art systems to model the interaction between the node and the unknown service. The dynamic conversation selection mechanism of the present invention automatically selects at run-time a conversation logic that is suitable or compatible with the dynamically selected service, thereby providing a mechanism to model the interaction between a node and a service that is unknown at the time the workflow is specified.

Adaptive Service Processes

In order to manage and even take advantage of the frequent changes in the environment, service processes need to be adaptive (i.e., capable of adjusting themselves to changes in the environmental conditions with minimal or no manual intervention). The service engine (e.g., eFlow) provides several features and constructs to achieve this goal. These include dynamic service discovery, dynamic conversation selection, multiservice nodes, and generic nodes. Dynamic service discovery and dynamic conversation selection are now described.

Dynamic Service Discovery

A service node represents the invocation of a basic or composite service. Besides defining the data that the node is allowed to read and modify, the certificate to be used in invoking the service, and possibly exception handling behaviors, a service node specification includes the description of the service to be invoked. For instance, within the Advertisement service node, we may specify that eFlow should invoke the e-campaign service offered by the GreatAdvert.com provider. While useful in some situations, such a static service binding is often too rigid, since it does not allow to:

1) select the appropriate service depending on the customer's requirements: for instance, some customers may prefer a low-cost e-mail campaign, while other may prefer advertisements via TV, radio stations, or web sites;

2) decouple service selection from the process definition: different service processes may require an advertisement service, and the selection criteria may need to be defined at the company level rather than at the composite service level;

3) dynamically discover the best currently available service that fits the need of a specific customer.

To cope with the characteristics of the Internet environment, eFlow service nodes include the specification of a service selection rule, which can have several input parameters (defined by references to case packet variables). When a service node is started, the eFlow engine issues a query to the ESP that will execute the specified rule and return a reference to a service whose description satisfies the constraints in the rule. Service selection rules are defined in an ESP specific language: the eFlow engine does not interpret the rules, but simply transfers them along to the ESP for execution. TABLE II illustrates an exemplary e-speak service selection query. The query selects a restaurant in Como, Italy, with sufficient seating capacity. In the example, the seating capacity is not statically specified but it is determined by the value of a case packet variable min_capacity. In this way, the selection depends on instance-specific attributes, and is therefore tailored to the needs of the customer of the award ceremony composite service.

TABLE II
<?xml version=“1.0”?>
<esquery xmlns=“http://www.e-speak.net/Schema/E-speak.query.xsd” >
<from src=“es: //locahost:12346”/>
<vocabulary name=“restaurant” src=“restaurant-simple”/>
<result> $serviceInfo </result>
<where>

<!-- find restaurants in Como,Italy, with enough seating capacity -->
<condition>restaurant:City =&apos;Como&apos; and
restaurant:Country =&apos;Italy&apos; and
restaurant:Capacity &gt; %min_capacity%</condition>

</where>
<preference>

<!-- sort the results by their price, the cheaper the better -->
<operator>min</operator>
<expr> restaurant: PricePerPerson </expr>

</preference>
<arbitration>

<!-- Return only one match, i.e., find only the cheapest-->
<cardinality>1</cardinality>

</arbitration>
</esquery>

The workflow engine (e.g., the eFlow engine) requires that at most one service reference is returned by the ESP (except for multiservice nodes, discussed later in this section). If the service selection query has more than one match on the ESP, the eFlow/ESP adapter takes the best match (if the query included ranking criteria), or otherwise chooses a service in a non-deterministic way. If no service is found, then an exception is raised. The exception is then managed according to the exception handling rules specified at the composite service level.

Dynamic Conversation Logic Selection

The dynamic service discovery feature introduced previously allows the workflow engine (e.g., eFlow engine) to select the best available service at the time the service node is started, based on the requirements imposed by the service selection rule. While this feature provides flexibility and enables the choice of the service based on the characteristics of the specific composite service instance in which the node is executed (e.g., may be based on the value of case packet data items), it introduces the issue of managing the conversation with the dynamically selected service.

In fact, different providers may offer the same type of service. While in some cases industry standards (such as RosettaNet, which is described further at www.rosettanet.org) define the interface that a service of a given type should offer, in many cases, different providers specify different interfaces for the same type of service. Consequently, if the conversation (i.e., the flow of method invocations) is statically defined at composite service definition time, there is the risk that the conversation itself is not consistent with the interface provided by the dynamically selected service.

The composite service designer can cope with this problem in two ways:

1) Impose in the service selection rule that the service complies with a given conversation protocol. For example, many ESPs enable the specification of constraints over the service conversation protocols in the selection query.

2) Leverage the dynamic conversation logic selection mechanism provided by the present invention, as discussed previously.

By using dynamic conversation logic selection, the designer is not required to define the conversation at specification time. Instead, the designer can specify that the conversation within a given service node should be selected at run time, based on the service returned by the execution of the service selection query.

In one embodiment, the conversation logic selection is performed as follows. The workflow system (e.g., eFlow) maintains a repository of conversation logic or protocols. Each conversation logic can be associated to one or more services. For instance, when there are four advertisement services (e.g., services A, B, C, and D) on the market that can serve the needs of the composite service provider, and A and B have the same interface, then the designer may define three conversations in the repository. A first conversation logic for services A and B. A second conversation logic for service C, and a third conversation logic for service D. Next, the designer specifies within the Advertisement service node that the conversation logic is to be dynamically selected. At run-time, when the workflow engine executes the service node, the engine sends a service selection query to the ESP. Based on the service returned, the DCLSM selects the appropriate conversation logic from the repository.

Entries in the conversation logic repository can be either for exclusive use of a given composite service or shared by all composite services. Preferably, when dynamic conversation selection is employed, the designer ensures that the service selection query restricts the search to those services for which there is an entry in the conversation logic repository.

Dynamic conversation logic selection has the purpose of making dynamic service selection practically applicable in those areas where the service interfaces are not standardized, and where it is not effective to limit the search to services with specific interfaces.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for selecting a conversation logic at run-time for a workflow definition that includes at least one node with no hard-coded conversation logic, the method comprising the steps of:
a) maintaining a conversation logic repository that includes at least one conversation logic that is external to the workflow definition;
b) when executing the node with no hard-coded conversation logic, dynamically discovering a service associated with the node with no hard-coded conversation logic;
c) determining a corresponding conversation logic in the conversation logic repository based the discovered service; and
d) dynamically plugging in the determined conversation logic into the node at run time.

2. The method of claim 1
wherein the step of when executing the node with no hard-coded conversation logic, dynamically discovering a service associated with the node with no hard-coded conversation logic includes the steps of:
determining a service based on a service selection rule;
receiving a service reference; and
wherein the step of determining a corresponding conversation logic in the conversation logic repository based the discovered service further includes the steps of
using the service reference to determine a conversation logic for the determined service.

3. A method for selecting a conversation logic at run-time comprising the steps of:
maintaining a conversation logic repository that includes at least one conversation logic;
at run-time, sending a service selection query to an electronic services platform or other service broker;
receiving a returned service identifier or reference; and
selecting a conversation logic from the repository of conversation logics based on a returned service identifier.

4. The method of claim 3 wherein each conversation logic is associated with at least one service.

5. The method of claim 3 wherein the conversation logic is for the exclusive use of a given composite service.

6. The method of claim 3 wherein the conversation logics is shared by two or more composite services.

7. The method of claim 3 wherein the conversation logic is not defined in the workflow at process definition time.

8. The method of claim 3 further comprising the step of:
interacting with a dynamic service discovery mechanism; and
dynamically discovering services.

9. The method of claim 3 further comprising the step of:
performing late binding of the conversation logic at run-time.

10. The method of claim 3 wherein the repository is one of a single central database and multiple distributed files.

11. A system for dynamically selecting a conversation logic at run-time for a workflow definition that includes at least one node with no hard-coded conversation logic comprising:
a) a workflow engine for processing workflow definitions;
b) a conversation logic repository that includes at least one conversation logic and that is external to the workflow definition;
c) a dynamic conversation logic selection mechanism for receiving a service identifier that is associated with a service at run-time and based thereon for selecting a conversation logic for interacting with the service at run-time.

12. The system of claim 11 further comprising:
d) a source for services; wherein the source discovers services based on a service selection rule;
wherein the dynamic conversation logic selection mechanism (DCLSM) selects appropriate conversation logic from the conversation logic repository based on a discovered service.

13. The system of claim 11 wherein the source for services is one of a service broker, a service marketplace, an e-services platform, a company, and an entity.

14. The system of claim 11, wherein only services that have a conversation protocol compatible with one of the conversation logics available in the repository are selected.

15. The system of claim 11 wherein each conversation logic is associated with at least one service.

16. The system of claim 11 wherein the conversation logic is for the exclusive use of a given composite service.

17. The system of claim 11 wherein the conversation logics is shared by two or more composite services.

18. The system of claim 11 wherein the conversation logic is not defined in the workflow at process definition time.

19. The system of claim 11 wherein the dynamic conversation logic selection mechanism performs late binding of the conversation logic at run-time.

20. The system of claim 11 wherein the conversation logic repository is one of a single central database and multiple distributed files.
